(19) United States
(12) Patent Application Publication
(10) Pub. No.: US 2017/0014978 A1
(43) Pub. Date: Jan. 19, 2017

(54) Method for making a bit

(71) Applicant: Tuo-Jen Chen, Taichung (TW)

(72) Inventor: Tuo-Jen Chen, Taichung (TW)

(21) Appl. No.: 14/798,438

(22) Filed: Jul. 13, 2015

(51) Int. Cl. B25B 15/00; B23P 15/00

(52) U.S. Cl. CPC B25B 15/001; B23P 15/00

(57) ABSTRACT

A method for making a bit includes a step of preparing a bar of pre-set length, the bar having two lateral portions on two opposite sides thereof, and two engaging faces formed on each of the top and the bottom of the bar, the engaging faces being in contact with at least two face insides of a hexagonal hole of an accommodation tool, a distance X1 defined between the two engaging faces, a distance Y1 defined between the two lateral portions 11, X1≧1.2 Y1; a step of forming each of two ends of the bar into a function end, a connection portion being formed between the two function ends, and a step of obtaining the bit. The bit is compact and light weight.

### BACKGROUND OF THE INVENTION

1. Fields of the invention

The present invention relates to a method for making a bit which is light in weight and compact.

2. Descriptions of Related Art

The conventional bit 10 as disclosed in FIGS. 1 and 2 includes a driving end 11 and a connection end 12, a neck 13 is connected between the driving end 11 and the connection end 12. The driving end 11 is used to drive a screw 14 which has a head 141 with different sizes, and the head has a recess 42 of different shapes so as to be engaged with different shapes of the driving end 11, such as hexagonal driving end, Phillip driving end or any known shaped driving end. The connection end 12 is connected with an accommodation tool such as a socket 151 of a tool 15. The socket is rotated to rotate the driving end 11 to fastening the screw 14.

However, the socket 151 has a hexagonal hole of 6.35 mm, so that the connection end 12 of any type of the bits 10 has to be cooperated with the hexagonal hole, regardless of the shape or size of the driving end 11. In other words, no matter what shape or size of the driving end 11 and/or the neck 13 is made, the connection end 12 has the restriction of being the same size and shape. This may occupy a lot of storage or transportation space.

As shown In FIGS. 3 and 4, in order to reduce the weight, some bits 10 has a hollowed area 101 in the head thereof, nevertheless, the storage or transportation space is not changed.

FIGS. 5, 6 and 7 show the tool boxes 161, 162 that have recesses 163, 164 to receive the bits 10, although the more recesses 163, 164 are provided, the heavier the weight reaches. Therefore, when the user carries more bits 10 by using the tool boxes 161, 162, the user has to bear the significant weight to work.

FIG. 8 shows a hand tool 17 that has a space 171 defined in the handle and multiple recesses 172 are provided in the space 171 so as to accommodate the bits 10 therein. When the conventional bits 10 have the same shape and volume, the problem mentioned above is not improved.

FIGS. 9 and 10 show that the bits 18, 19 each have a distinguishable portion 181/191 to attract the uses to purchase. However, the fancy distinguishable portions 181, 191 do not improve the problem of weight and size.

Besides, it takes extra cost to make the distinguishable portion 181, 191 by either using plastic injection molding or color shrinking film. In addition, the bit 18 as shown in FIG. 9 has to be made with a groove to accommodate the distinguishable portion 181. The distinguishable portion 181/191 has to be firmly attached to the bit 18/19 at a small area, and this is a challenge which means more time and labor are required.

FIGS. 11 and 12 show the method for making the conventional bit 10 and comprising:

a step of preparing: preparing a cylindrical bar of pre-set size;

a step of extrusion: extruding the cylindrical bar into a bar with a hexagonal cross section;

a step of cutting: cutting the bar in the previous step into sections according to the length of the bit 10;

a step of making notches: making notches 121 in the connection portion 12 of the bit 10 so as to position the connection portion 12 in the socket 151, inclined edges 122 being cut along a periphery of the end of the connection portion 12;

a step of lathing: lathing the front end of the bit 10 to a standard size; and

a step of forming the driving end: cutting the front end of the bit 10 into the driving end 11 as shown in FIG. 12.

There are multiple steps involved and a lot of material is wasted. Multiple steps of lathing and cutting reduces the efficiency of manufacturing and the yield rate. Again, the weight and volume problems are not improved.

The present invention intends to provide a method for making a bit so as to eliminate the shortcomings mentioned above.

### SUMMARY OF THE INVENTION

The present invention relates to a method for making a bit, and comprises the following steps:

a step of preparing: preparing a bar of pre-set length, the bar having two lateral portions on two opposite sides thereof, and two engaging faces formed on each of a top and a bottom of the bar, the engaging faces connected to the two lateral portions and to be in contact with at least two face insides of a hexagonal hole of an accommodation tool, a peak formed on a connection between the two engaging faces of each of the top and the bottom of the bar, the distance X1 defined between the two peaks, and the distance Y1 defined between the two lateral portions, X1≧1.2 Y1;

a step of forming function ends: forming each of two ends of the bar 1 into a function end, a connection portion formed between the two function ends, and

a step of obtaining a product: the bit being obtained.

Preferably, the step of forming function ends further comprises a step of making notches, wherein multiple notches are make in the connection portion.

The present invention also provides another method for making a bit, and the method comprises the following steps:

a step of preparing: preparing a bar of pre-set length, the bar having two lateral portions on two opposite sides thereof, each of the two lateral portions having two elongate sides and an auxiliary engaging face extending inclined from each of the two elongate sides of each of the two lateral portions, a connection face connected between the two auxiliary faces on each of a top and a bottom of the bar, the width of each of the auxiliary engaging faces being smaller than that of each of insides of a hexagonal hole of an accommodation tool, the distance X2 defined between the connection faces, the distance Y2 defined between the two lateral portions, X2≧1.2 Y2;

a step of forming function ends: forming each of two ends of the bar into a function end, a connection portion formed between the two function ends, and

a step of completing a product: the bit being obtained.

Preferably, the step of forming function ends further comprises a step of making notches, wherein multiple notches are make in the connection portion.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the conventional bit;

FIG. 2 shows the conventional bit, a screw and a tool;

FIG. 3 is a perspective view to show another conventional bit;

FIG. 4 is a cross sectional view of the conventional bit in FIG. 3;

FIG. 5 shows the conventional bit and a tool box;

FIG. 6 shows multiple conventional bits and a tool box;

FIG. 7 shows that the multiple conventional bits are received in the tool box of FIG. 6;

FIG. 8 shows multiple conventional bits are received in a handle of a tool;

FIG. 9 shows the conventional bit having a distinguishable portion;

FIG. 10 shows another conventional bit having a distinguishable portion;

FIG. 11 shows the steps of the method for making the conventional bit;

FIG. 12 shows the conventional bit made by the method in FIG. 11;

FIG. 13 shows the steps of the method of the present invention;

FIG. 14 shows the bar in the step of preparing of the method of the present invention;

FIG. 15 shows that the cross sectional area of the bit of the present invention accommodated in an accommodation tool;

FIG. 16 shows the relationship of the distances X1 and Y1 of the bit of the present invention;

FIG. 17 shows the bit made by the method of the present invention;

FIG. 18 shows that the connection of the bit of the present invention is accommodated in the accommodation tool, wherein the space is saved;

FIG. 19 shows that notches are defined in the connection portion of the bit of the present invention;

FIG. 20 shows the notches of a 50 mm bit made by the method of the present invention;

FIG. 21 shows the steps of the second embodiment of the method of the present invention;

FIG. 22 shows the bar in the step of preparing of the method in FIG. 21;

FIG. 23 shows that the cross sectional area of the bit of the present invention accommodated in an accommodation tool;

FIG. 24 shows the relationship of the distances X2 and Y2 of the bit of the present invention;

FIG. 25 shows the bit made by the method of the present invention in FIG. 21;

FIG. 26 shows that notches are defined in the connection portion of the bit made by the method in FIG. 21, and

FIG. 27 shows the notches of a 50 mm bit made by the method in FIG. 21.

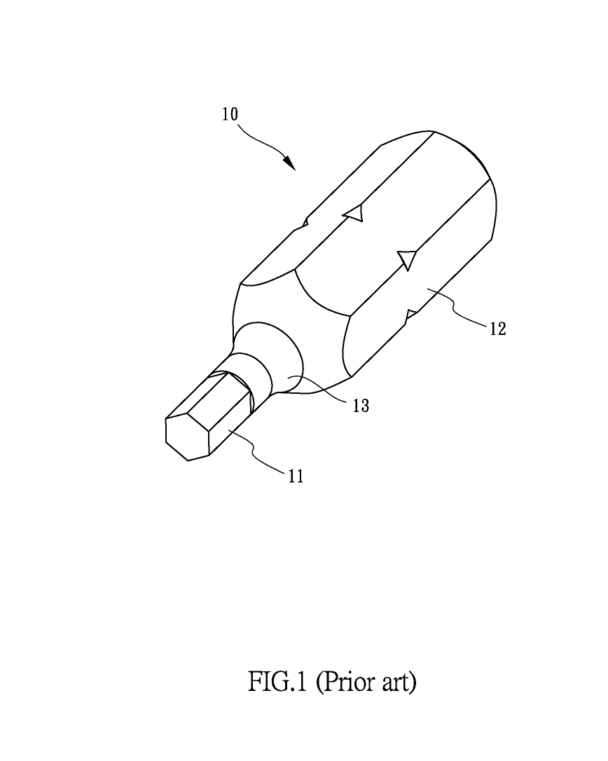

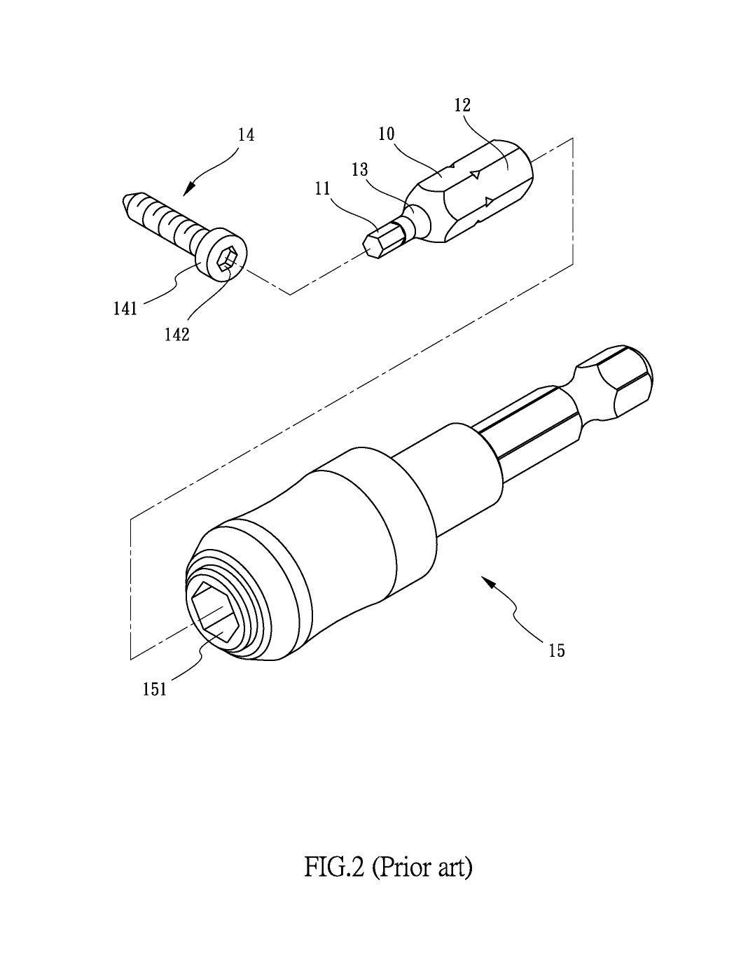

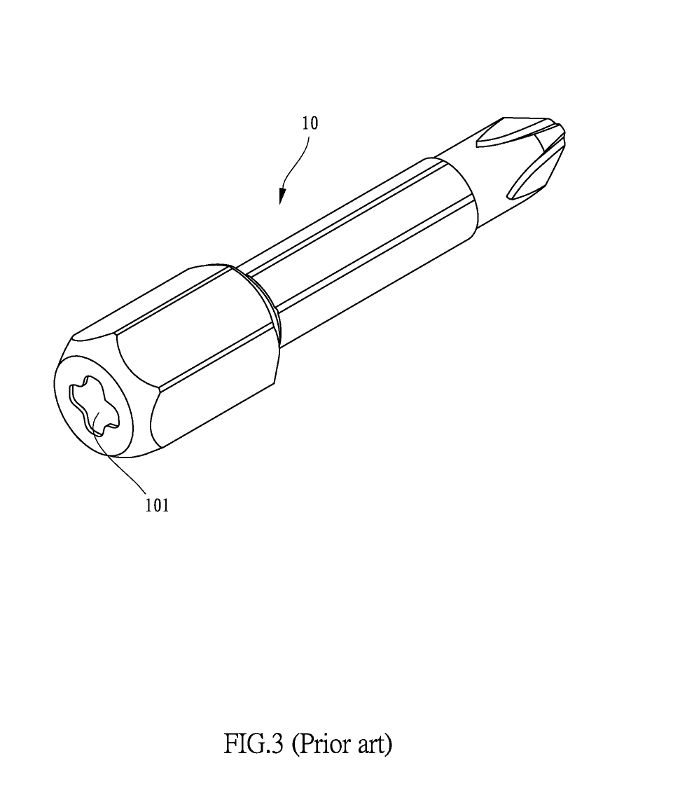

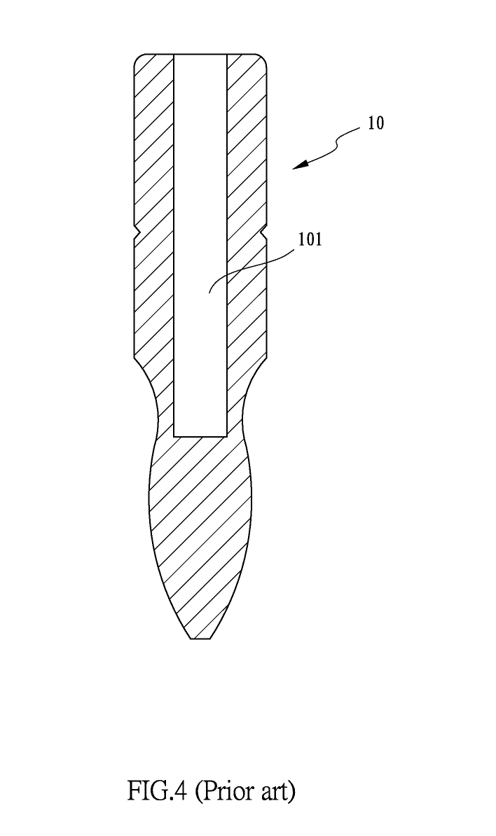

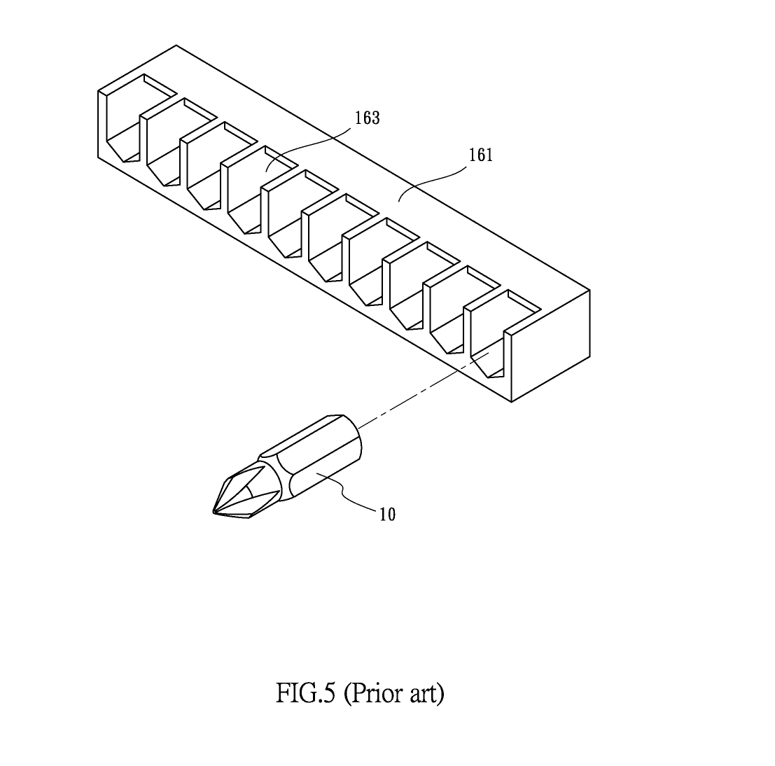

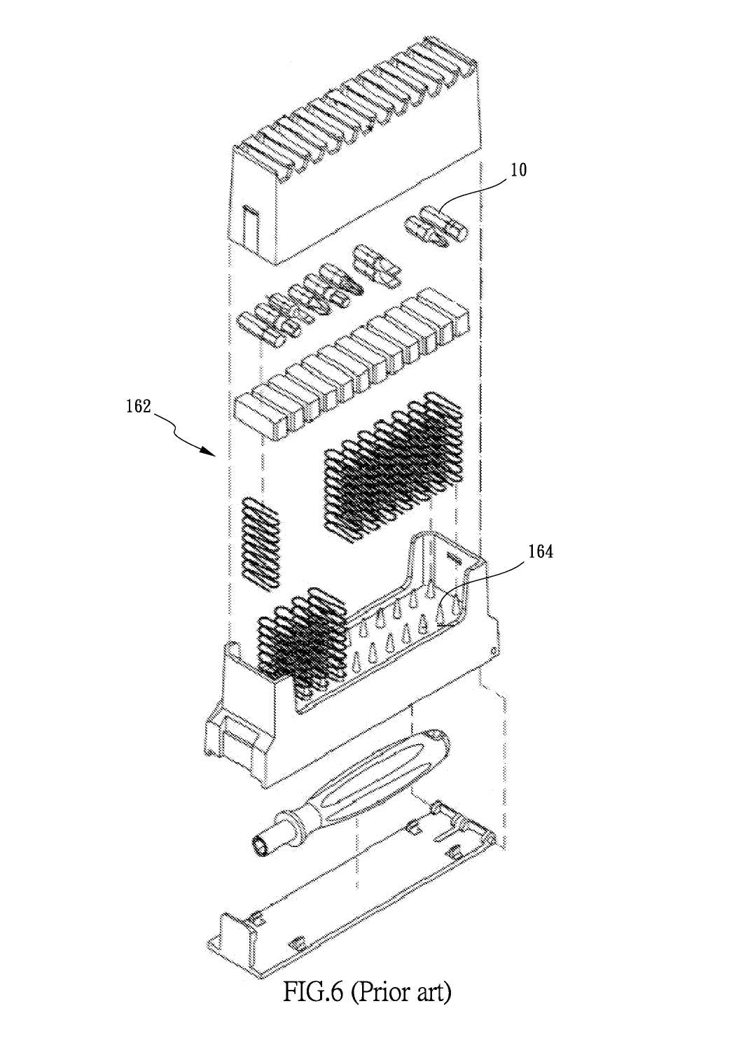

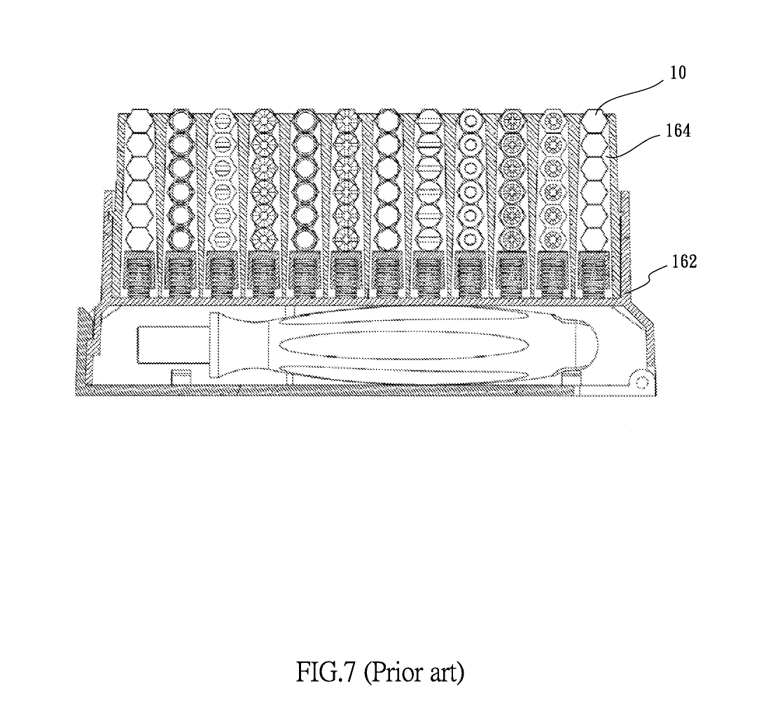

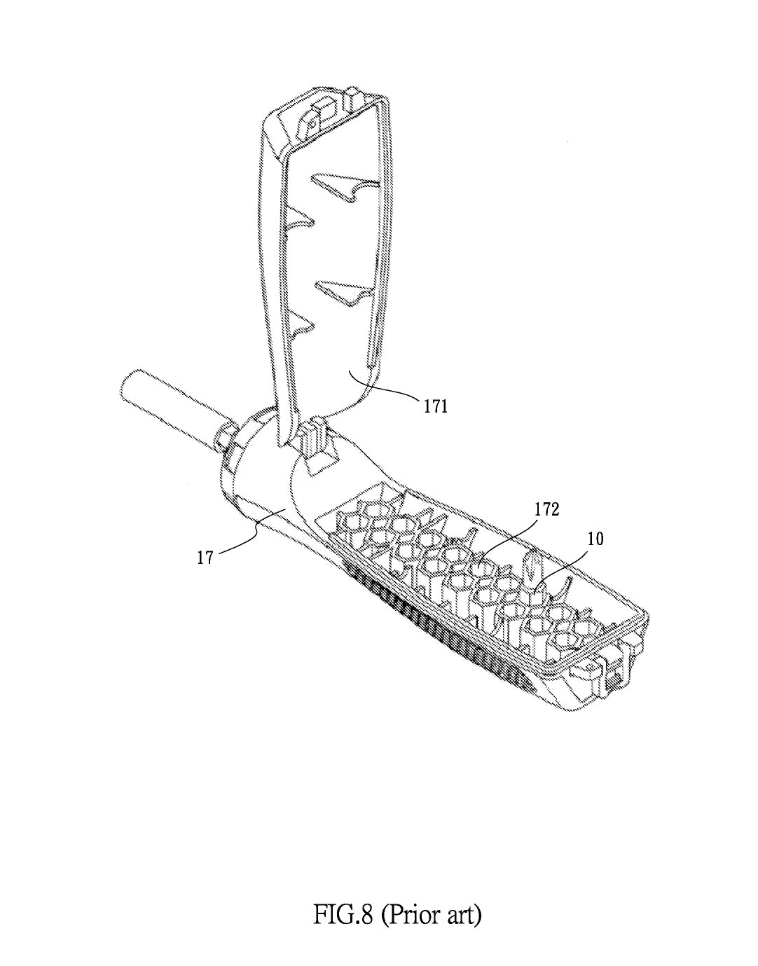

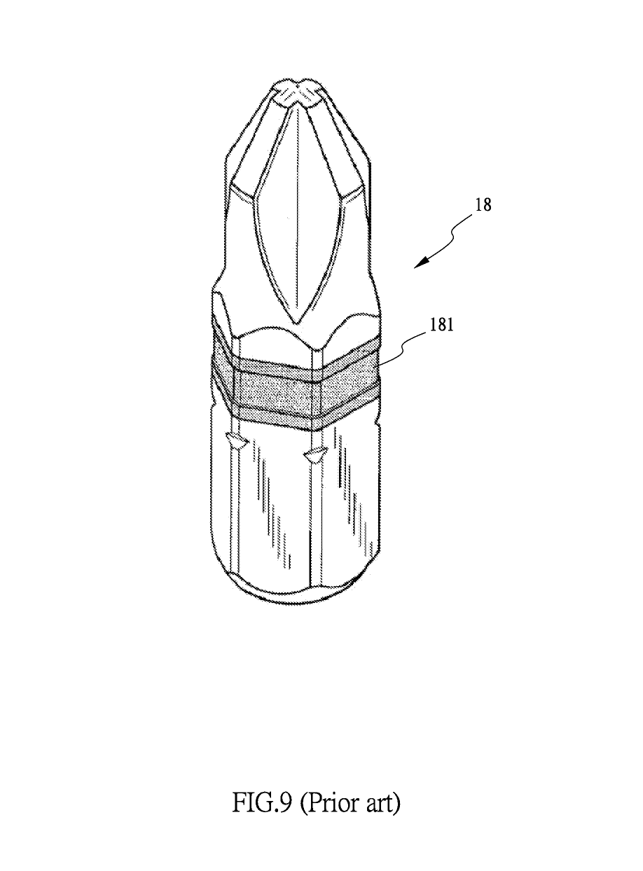

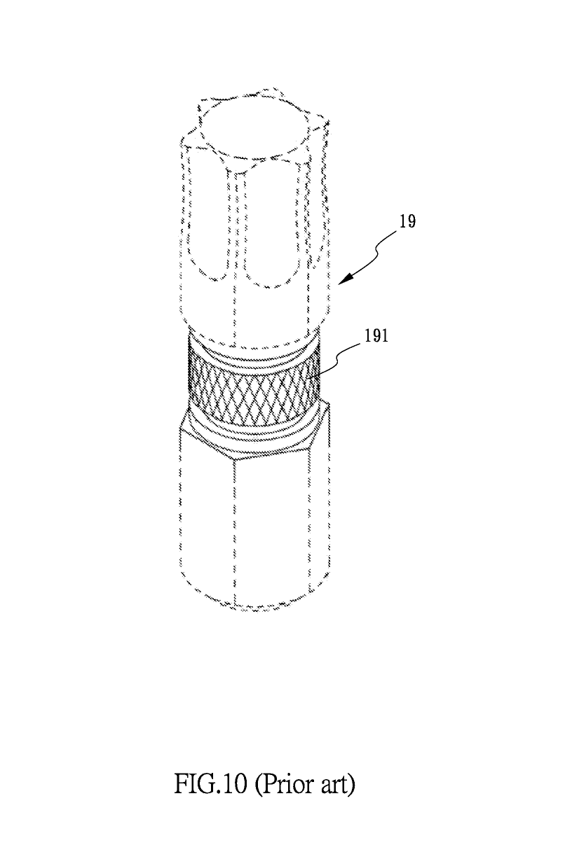

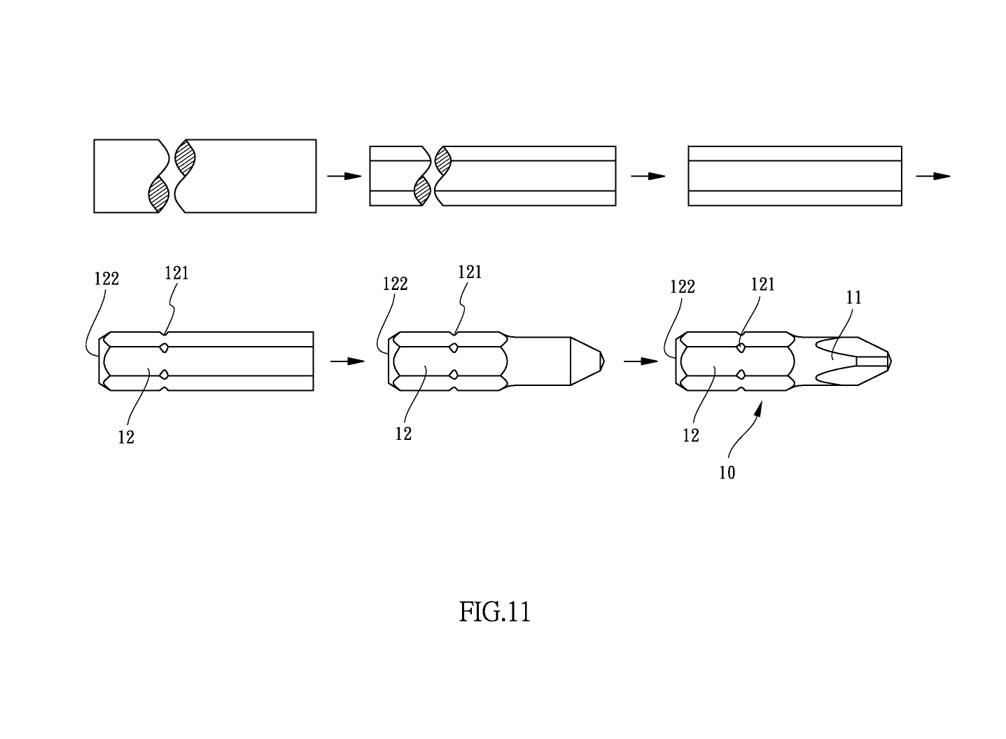

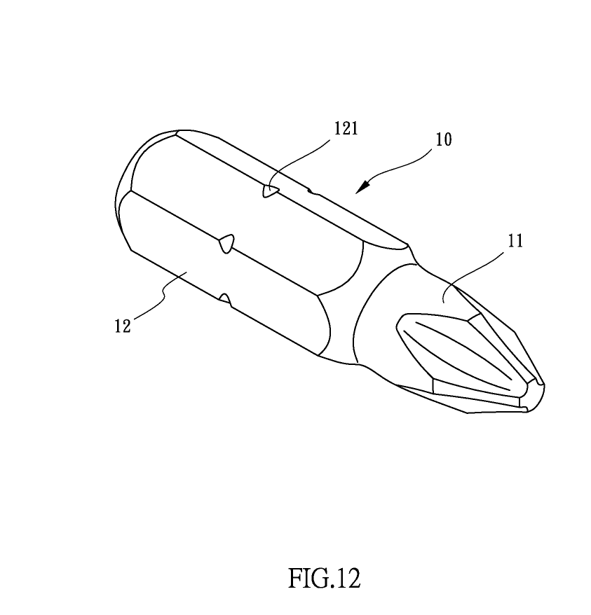

### DETAILED DESCRIPTION OF THE PREFERRED EMBODIMENT

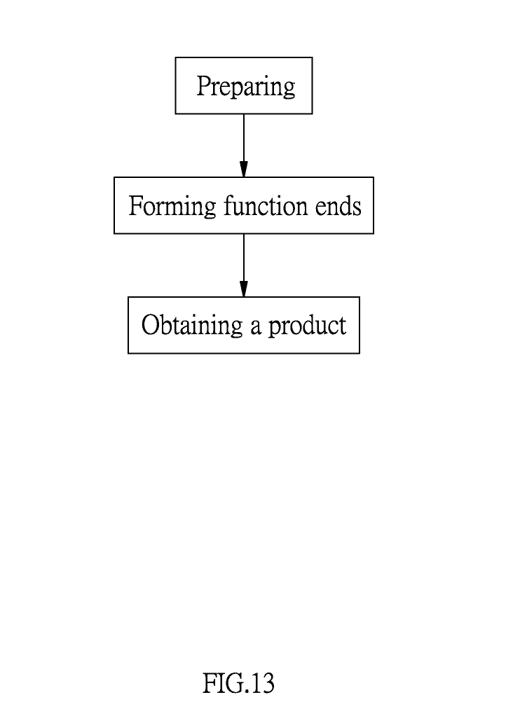

Referring to FIGS. 13 to 16, the method of the present invention comprises the following steps:

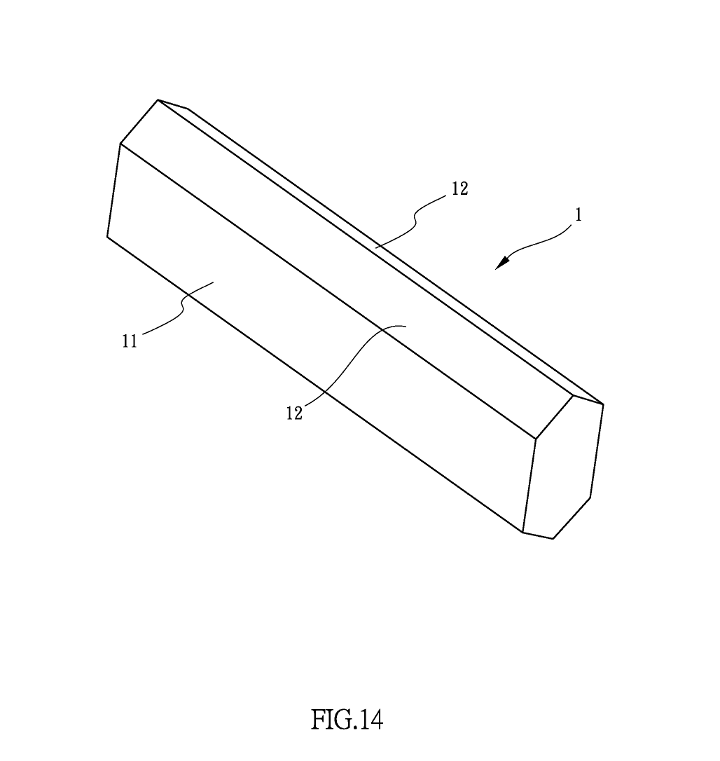

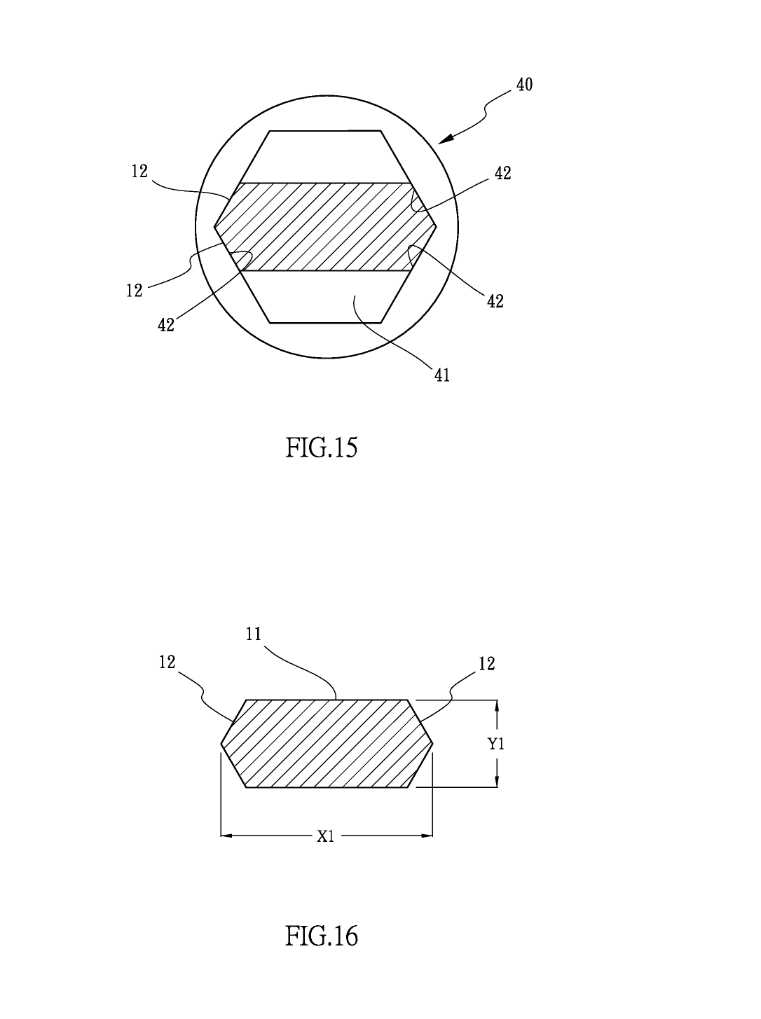

a step of preparing: preparing a bar 1 of pre-set length as shown in FIG. 14, the bar 1 having two lateral portions 11 on two opposite sides thereof, and two engaging faces 12 formed on each of a top and a bottom of the bar 1, the engaging faces 12 connected to the two lateral portions 11 and adapted to be in contact with at least two face insides 42 of a hexagonal hole 41 of an accommodation tool 40 as shown in FIG. 15, a peak formed on a connection between the two engaging faces 12 of each of the top and the bottom of the bar 1, a distance X1 defined between the two peaks, a distance Y1 defined between the two lateral portions 11, X1≧1.2 Y1 as shown in FIG. 16;

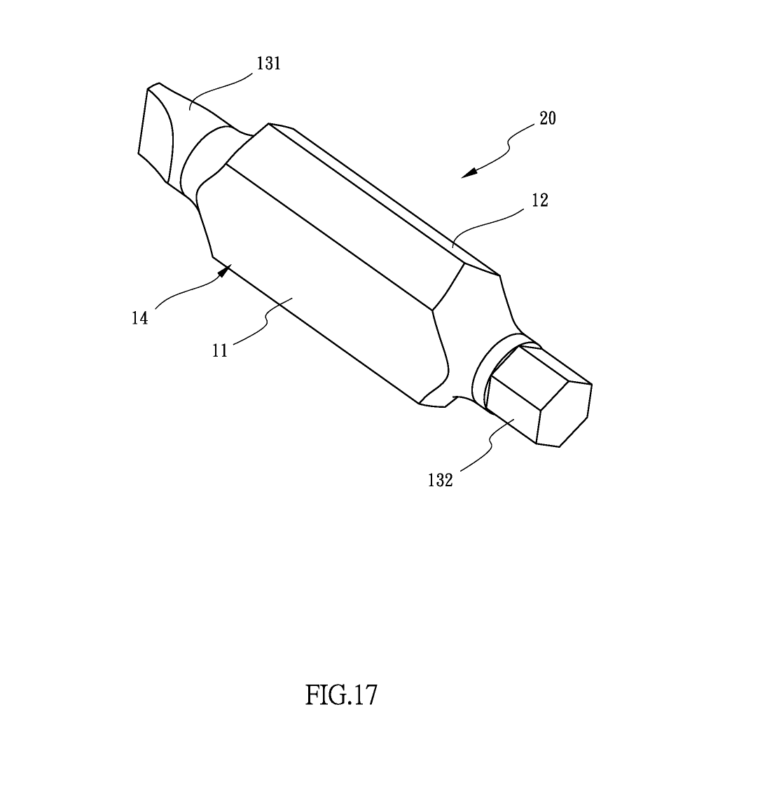

a step of forming function ends: forming each of two ends of the bar 1 into a function end 131/132 as shown in FIG. 17, a connection portion 14 formed between the two function ends 131, 132, and

a step of obtaining a product: the bit 20 being obtained.

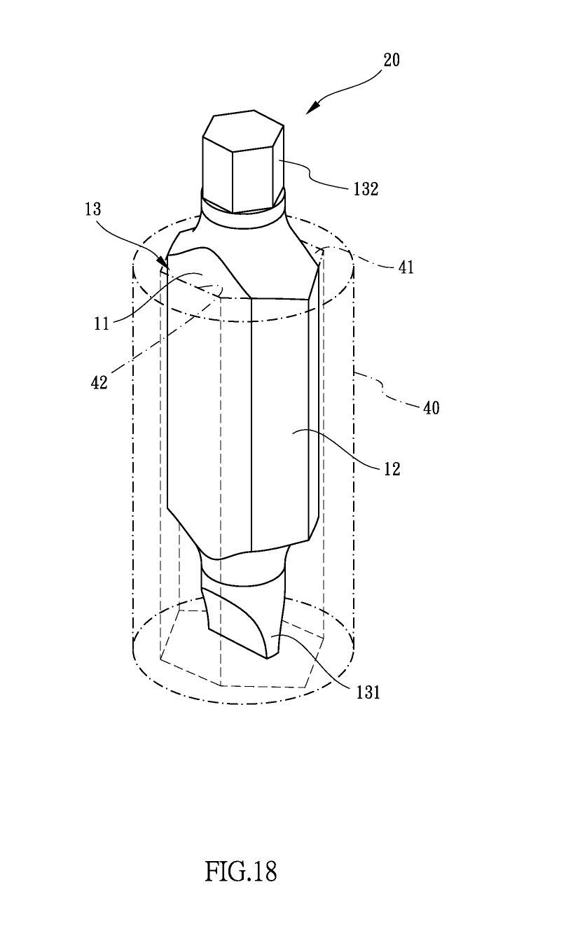

The engaging faces 12 of the connection portion 14 of the bit 20 of the present invention are in contact with the face insides 42 of the hexagonal hole 41 of the accommodation tool 40 as shown in FIG. 15. The relationship of the distance X1 and the distance Y1 is defined as X1≧1.2 Y1 as shown in FIG. 16, so that the strength of the bit 20 is strong enough while the bit 20 is compact, so that spaces 13 are saved when used with hexagonal hole 41 of the accommodation tool 40 as shown in FIG. 18. The saved spaces 13 means that the volume of the bit 20 is smaller than the conventional bits, so that the weight of the bit 20 is reduced. Besides, because the lateral portions 11 are big enough which can be used as a distinguishable portion and the manufacturing steps are easier than the conventional methods. The engaging faces 12 are able to contact the insides 42 of the hexagonal hole 41 of the accommodation tool 40 so that the bit 20 can be used with the conventional accommodation tool such as a socket. The bit 20 does not need to make a hollow head to reduce its weight. Even the same number of the bits 20 are received in a tool box, the total weight is reduced.

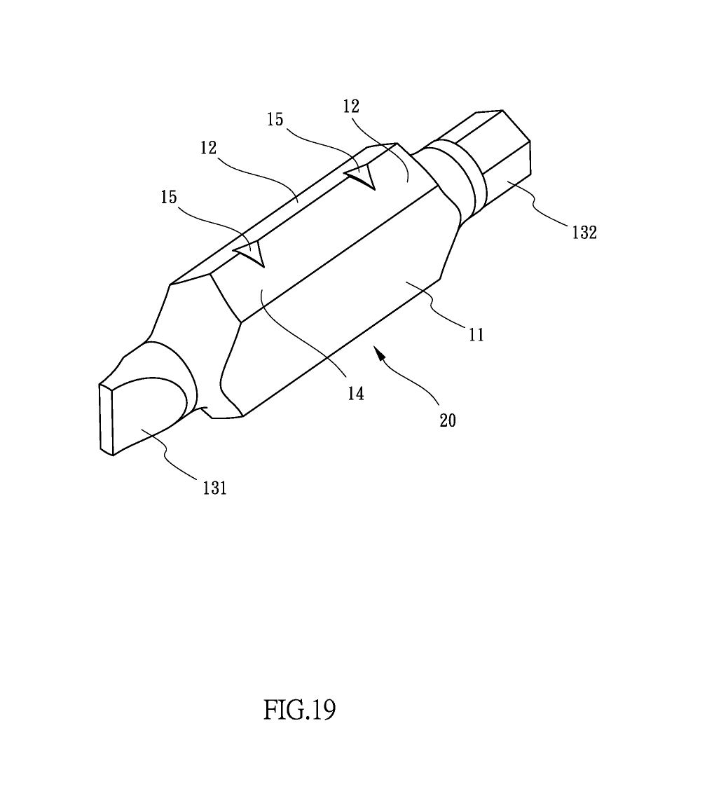

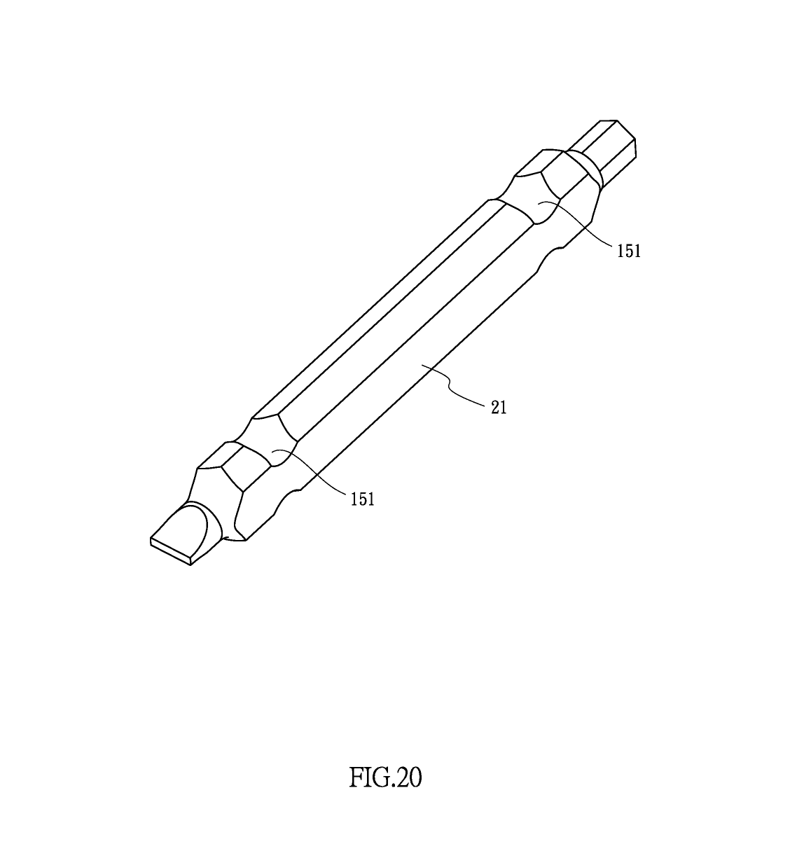

As shown in FIG. 19, the step of forming function ends further comprises a step of making notches, wherein multiple notches 15 are make in the connection portion 14. If the bit is a 50 mm bit 21, the notches 151 are made as shown in FIG. 20 so as to accommodate the positioning beads (not shown) of a power tool (not shown).

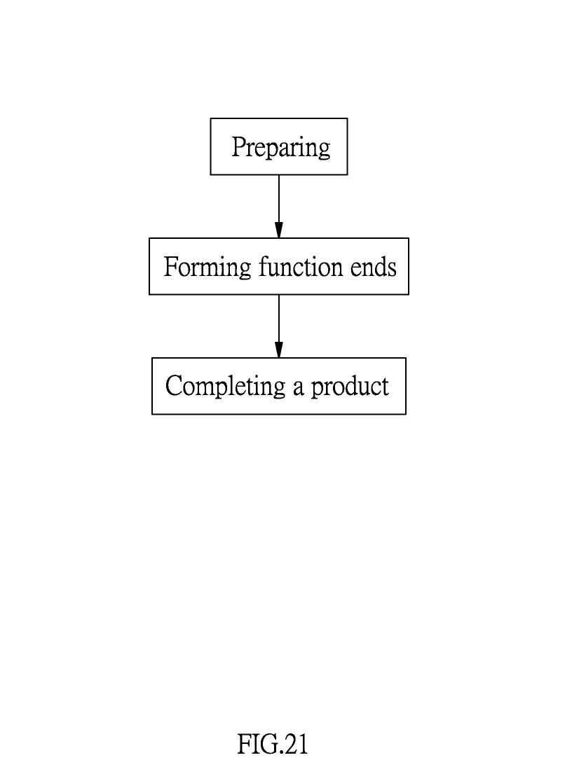

FIG. 21 shows the second embodiment of the method for making a bit, the method comprises the following steps:

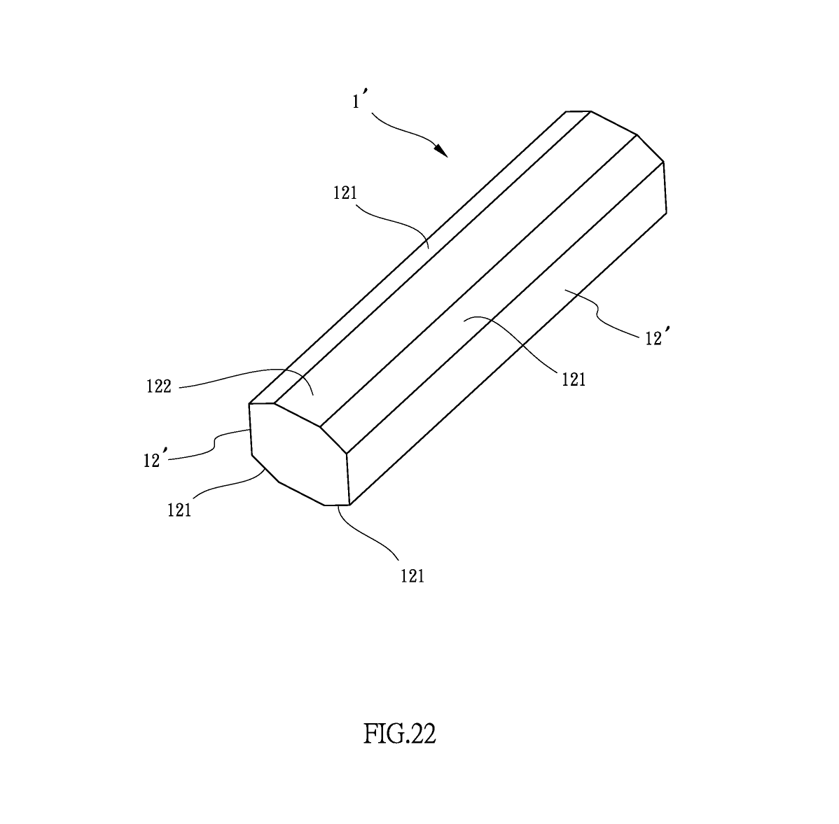

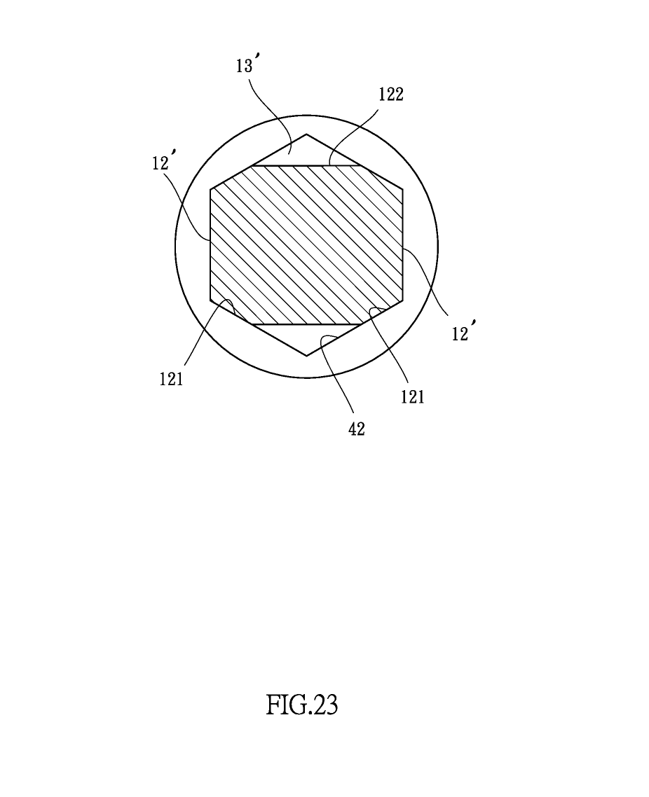

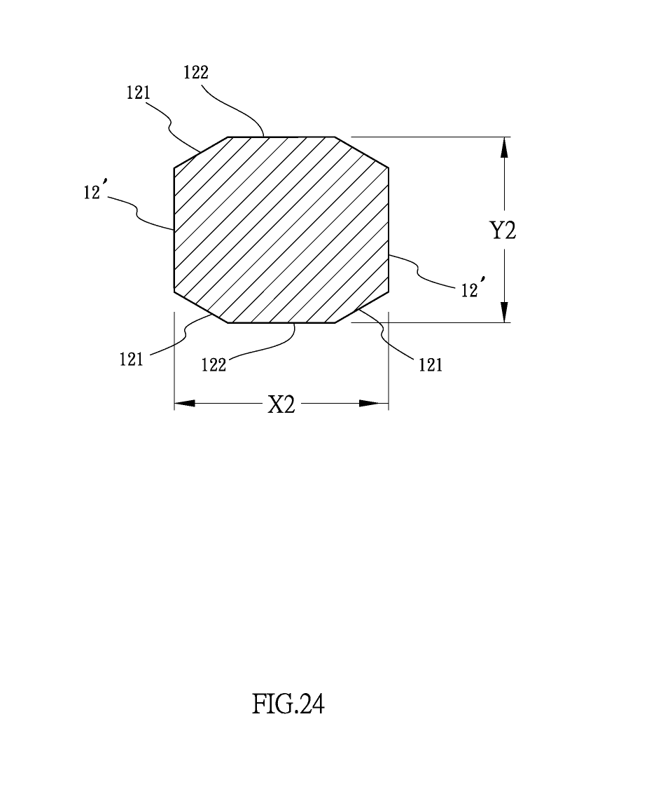

a step of preparing: preparing a bar 1′ of pre-set length, the bar 1′ having two lateral portions 12′ on two opposite sides thereof as shown in FIG. 22, each of the two lateral portions 12′ having two elongate sides and an auxiliary engaging face 121 extending inclined from each of the two elongate sides of each of the two lateral portions 12′, a connection face 122 connected between the two auxiliary faces 121 on each of a top and a bottom of the bar 1′, a width of each of the auxiliary engaging faces 121 being smaller than that of each of insides 42 of a hexagonal hole 41 of an accommodation tool 40 as shown in FIG. 23, a distance X2 defined between the connection faces 122, a distance Y2 defined between the two lateral portions 12′, X2≧1.2 Y2 as shown in FIG. 24;

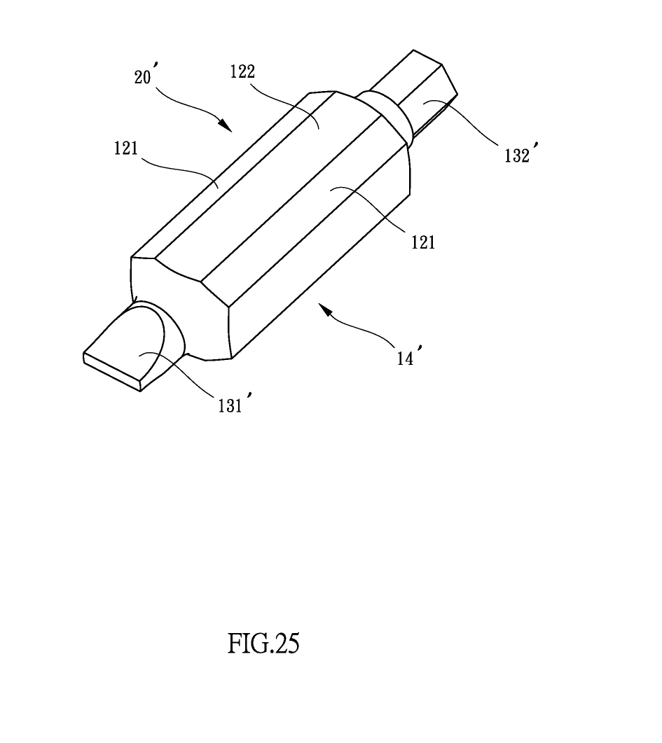

a step of forming function ends: forming each of two ends of the bar 1′ into a function end 131′/132′ as shown in FIG. 25, a connection portion 14′ formed between the two function ends 131′, 132′, and

a step of completing a product: the bit 20′ being obtained.

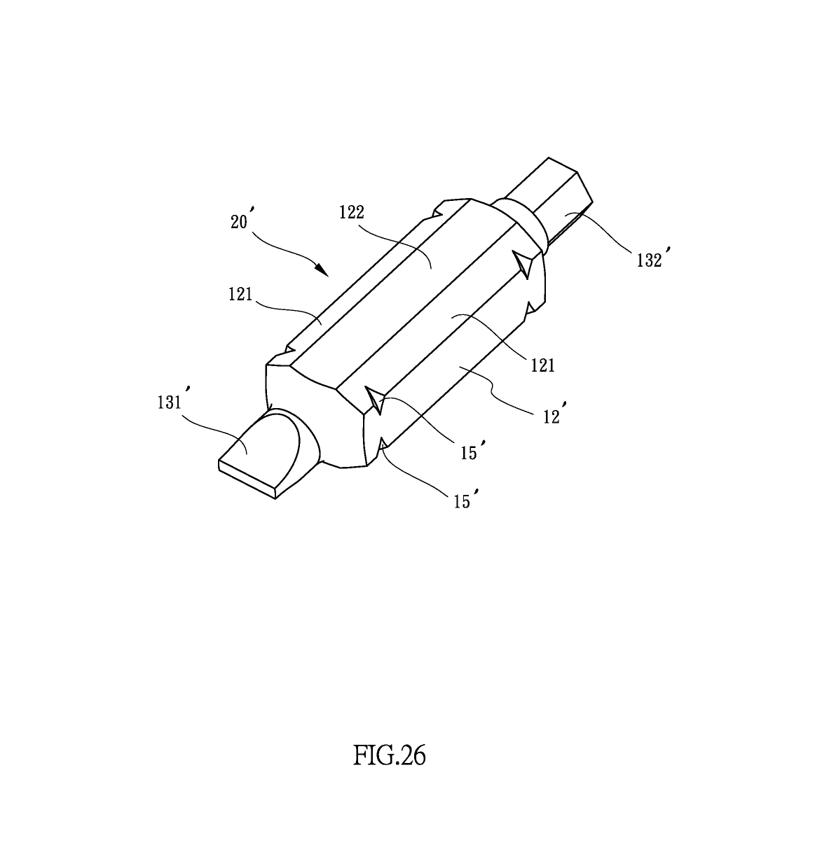

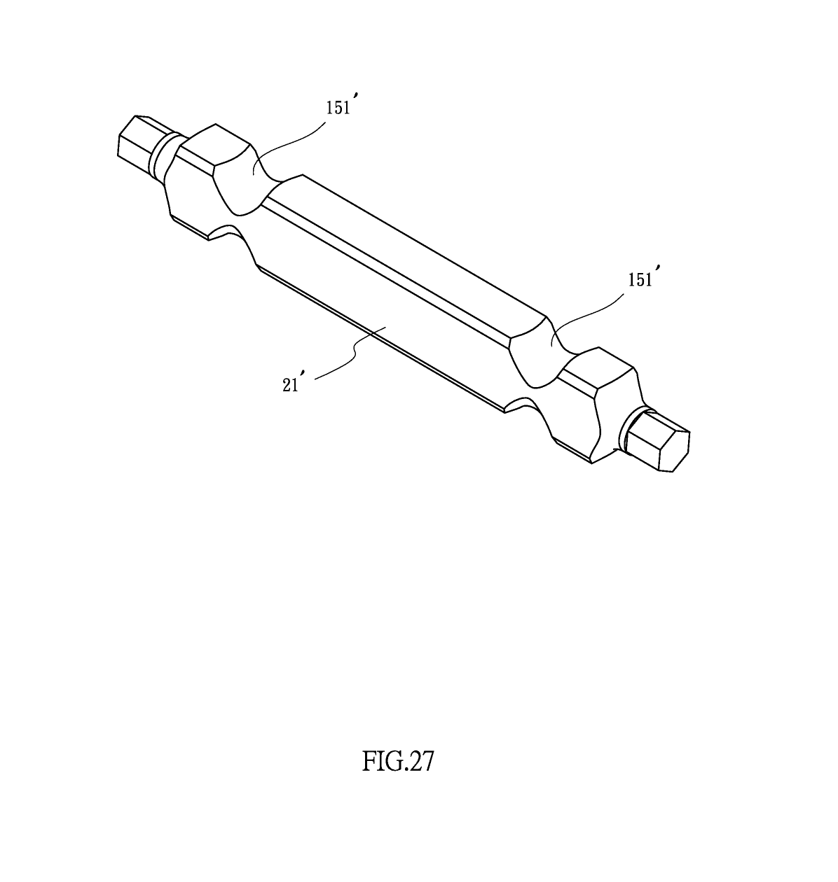

Preferably, the step of forming function ends further comprises a step of making notches, wherein multiple notches 15′ are make in the connection portion 14′ as shown in FIG. 26. If the bit is a 50 mm bit 21′, the notches 151′ are made as shown in FIG. 27 so as to accommodate the positioning beads (not shown) of a power tool (not shown).

The relationship of the distance X2 and the distance Y2 is defined as X2≧1.2 Y2, so that the strength of the bit 20′ is strong enough while the bit 20′ is compact, so that spaces 13′ between the bit 20′ and the insides of the hexagonal hole 41 of the accommodation tool 40 are saved as shown in FIG. 23. The saved spaces 13′ means that the volume of the bit 20′ is smaller than the conventional bits, so that the weight of the bit 20 is reduced.

While we have shown and described the embodiment in accordance with the present invention, it should be clear to those skilled in the art that further embodiments may be made without departing from the scope of the present invention.

What is claimed is:

1. A method for making a bit, comprising:
a step of preparing: preparing a bar of pre-set length, the bar having two lateral portions on two opposite sides thereof, and two engaging faces formed on each of a top and a bottom of the bar, the engaging faces connected to the two lateral portions and adapted to be in contact with at least two face insides of a hexagonal hole of an accommodation tool, a peak formed on a connection between the two engaging faces of each of the top and the bottom of the bar, a distance X1 defined between the two peaks, a distance Y1 defined between the two lateral portions, X1≧1.2 Y1;
a step of forming function ends: forming each of two ends of the bar into a function end, a connection portion formed between the two function ends, and
a step of obtaining a product: the bit being obtained.

2. The method as claimed in claim 1, wherein the step of forming function ends further comprises a step of making notches, wherein multiple notches are make in the connection portion.

3. A method for making a bit, comprising:
a step of preparing: preparing a bar of pre-set length, the bar having two lateral portions on two opposite sides thereof, each of the two lateral portions having two elongate sides and an auxiliary engaging face extending inclined from each of the two elongate sides of each of the two lateral portions, a connection face connected between the two auxiliary faces on each of a top and a bottom of the bar, a width of each of the auxiliary engaging faces being smaller than that of each of insides of a hexagonal hole of an accommodation tool, a distance X2 defined between the connection faces, a distance Y2 defined between the two lateral portions, X2≧1.2 Y2;
a step of forming function ends: forming each of two ends of the bar into a function end, a connection portion formed between the two function ends, and
a step of completing a product: the bit being obtained.

4. The method as claimed in claim 1, wherein the step of forming function ends further comprises a step of making notches, wherein multiple notches are make in the connection portion.
